(19) United States
(12) Patent Application Publication
(10) Pub. No.: US 2016/0180257 A1
(43) Pub. Date: Jun. 23, 2016

(54) AUTOMATIC CONVERSION OF FORMATTED TRAVEL INFORMATION

(71) Applicant: Expedia, Inc., Bellevue, WA (US)

(72) Inventors: Tristan Brian Rees, Issaquah, WA (US); Angus Yee-Jen Fan, Bellevue, WA (US)

(21) Appl. No.: 14/576,099

(22) Filed: Dec. 18, 2014

(51) Int. Cl. G06Q 10/02; G06Q 50/14

(52) U.S. Cl. CPC G06Q 10/02; G06Q 50/14

(57) ABSTRACT

The present disclosure relates to automatic conversion of travel data encoded in Computer Reservations System (CRS) format into corresponding human-readable information, and subsequent presentation of that human-readable travel information to a user to enable booking of a travel item corresponding to the travel item information. CRS systems and databases provide data encoded in formats that make it difficult for a travel agent to convey corresponding travel items to a user. The present disclosure provides systems and methods that can automatically convert encoded CRS travel data input through an agent communication interface into a human-readable representation of travel items available through an electronic travel item marketplace. The system can further present the human-readable representation to the user through a user chat interface, which enables the user to book the travel items without further actions by the travel agent.

### BACKGROUND

Computing devices and computing networks are frequently employed by users to make purchases. For example, a user may purchase an item from a network-based retailer using his or her personal computing device. In particular, the practice of booking travel items has been made significantly easier with the advent of network-based travel services. By employing network-based travel services, illustratively a user may communicate travel needs with a travel agent using Internet based chat systems. Based on the customer's travel needs, the travel agent often searches for and retrieves data from one or more Computer Reservations Systems (CRSs).

A CRS is a computerized system used to store and retrieve information and conduct transactions related to travel items. CRS may support query and retrieval of information supplied by multiple travel item providers, such as airlines, hotels, car rental agencies, cruise lines, bus services, etc., thereby making travel items available for booking, reservation, and/or purchase. Major CRS operations that book and sell tickets for multiple airlines are also known as Global Distribution System (GDS). GDS may also facilitate booking of hotel rooms, rental cars, airline tickets as well as activities and tours. CRSs are generally used by travel agents, not laypersons, because data retrieved from CRS is typically encoded with various acronyms, codes and grammar that are not comprehensible by a lay person.

Therefore, the travel agent usually needs to read and interpret retrieved CRS-formatted data and explain corresponding travel items to the customer. The travel agent may also need to rely on another form of communication (e.g. Email) to present matching travel items to the customer, before the travel agent can complete booking of a travel item on behalf of the customer.

### BRIEF DESCRIPTION OF THE DRAWINGS

The foregoing aspects and many of the attendant advantages will become more readily appreciated as the same become better understood by reference to the following detailed description, when taken in conjunction with the accompanying drawings. Throughout the drawings, reference numbers may be re-used to indicate correspondence between referenced elements. The drawings are provided to illustrate example embodiments described herein and are not intended to limit the scope of the disclosure.

FIG. 1 is a block diagram illustrating an embodiment of a networked computing environment 100 including a travel item marketplace 110 for automatic conversion of encoded travel data and presentation of human-readable travel information through chat interfaces.

FIGS. 2A and 2B are simplified block diagrams illustrating interactions among components of the networked computing environment 100 of FIG. 1 for presenting to a user human-readable travel information generated based on automatic processing of CRS-formatted travel data.

FIGS. 3A-C depict illustrative user interfaces displayed on an agent computing device 112 of FIG. 1 and used by a travel agent to automatically process CRS-formatted travel data and generate human-readable travel information for presentation to a user computing device 102 of the networked computing environment of FIG. 1.

FIG. 4 depicts an illustrative user interface displayed by a user computing device 102 of FIG. 1 and enabling a user to view and interact with human-readable travel information generated based on processed CRS-formatted travel data.

FIG. 5 is a flow diagram illustrating an embodiment of a travel data processing routine implemented by the travel item marketplace 110 of FIG. 1 to automatically process CRS-formatted travel data and generate human-readable travel information for presentation to a user.

### DETAILED DESCRIPTION

Generally described, aspects of the present disclosure relate to text-based interfaces for communications between travel agents and users. More specifically, aspects of the present disclosure relate to systems and methods that enable travel agents to provide human-readable travel information, as well as interfaces to book travel items corresponding to the human-readable travel information, based on encoded CRS data retrieved by the travel agent. For example, embodiments of the present application may be utilize to enable travel agents to copy directly encoded travel information, such as information retrieved from a GDS system, and paste the encoded travel information into a chat window for communication with a user. Thereafter, aspects of the present disclosure enable a system to automatically transform the encoded data into a human-readable format. In some instances, embodiments of the present disclosure may supplement the encoded data with additional information (e.g., as retrieved from supplemental travel information databases) prior to presentation to the user. Further, embodiments of the present application enable a user computing device to automatically create and transmit a request to book travel items corresponding to the presented travel information. In some instances, systems disclosed herein may process such a request automatically, such that the travel agent is not required to take any action to complete booking of the travel items. Accordingly, aspects of the present application may greatly improve a travel agent's ability to communicate with a user, by enabling direct translation of encoded data into human-readable form. Further, aspects of the present disclosure enable a user to directly acquire or book travel items presented by a travel agent, reducing the need to further communicate with the travel agent and improving the user's experience.

In accordance with an illustrative embodiment of the present disclosure, a user sends a request to a travel item marketplace for information regarding available travel items (e.g., flights available to be booked) via a network-based chat interface, such as a chat application executed on a smartphone. The travel item marketplace thereafter receives the request and dispatches it to a travel agent based, for example, on an availability or specialty of the travel agent. The travel agent searches one or more CRS systems for relevant CRS data, such as GDS flight data, that may match the user's request. As noted earlier, CRS data is typically encoded with various acronyms, codes or grammar that a layperson cannot interpret. The travel agent inputs retrieved CRS-formatted data into an agent-oriented interface associated with the travel item marketplace. The travel item marketplace analyzes the input, extracts information that identifies travel items, and retrieves relevant travel items, policies or other supplemental information expressed in human-readable format from various travel item information sources. For example, the travel item marketplace may retrieve flight reservation inventory, fare breakdown, seating map and availability, cancellation policy, rental car options, etc. The travel item marketplace then incorporates retrieved travel items and corresponding information into a travel information data object, which may serve as a basis for corresponding human-readable travel information to be presented to the user.

Thereafter, the travel item marketplace proceeds with generation and presentation of human-readable travel information based on the travel information data object. The travel item marketplace processes information included in the data object (e.g., calculating a cost of relevant travel items after applying corresponding policies) and then generates human-readable travel information based thereon. Thereafter, the travel item marketplace causes presentation of the human-readable travel information in the proper format to the user via the same network-based chat interface. In some embodiments, the travel item marketplace may transmit instructions to a computing device of the user to present the human-readable travel information in an associated user interface that includes one or more interactive areas, which enable the user to book travel items corresponding to the human-readable travel information or to explore more details regarding the travel items. The user views the human-readable travel information via the network-based chat interface and interacts with the associated user interface. For example, the user clicks a “Book” button incorporated in the associated user interface, which causes a computing device associated with the travel item marketplace to execute certain instructions to automatically complete booking of travel items corresponding to the presented travel information.

In some embodiments, the travel item marketplace may obtain revisions to the travel information data object from the travel agent. The travel item marketplace may transmit a representation of the travel information data object to a computing device utilized by the travel agent. The travel agent may review information included in the data object and make revisions. The revisions may correspond to error corrections, supplemental information, or selection of travel items or information that the travel agent wishes to present to the requesting user. In other embodiments, the travel agent may request and be presented with a preview of the human-readable travel information prior to its presentation to the user.

Though described herein with respect to specific types of travel services, embodiments of the present disclosure may be applied to any travel item, including but not limited to flights, accommodations, other transportation, activities, tours, travel insurance, day trips, or destination services. Moreover, aspects of the present disclosure may be applied with respect to other requests, and should not be construed to be limited to travel services unless explicitly stated otherwise.

### Overview of an Example Embodiment

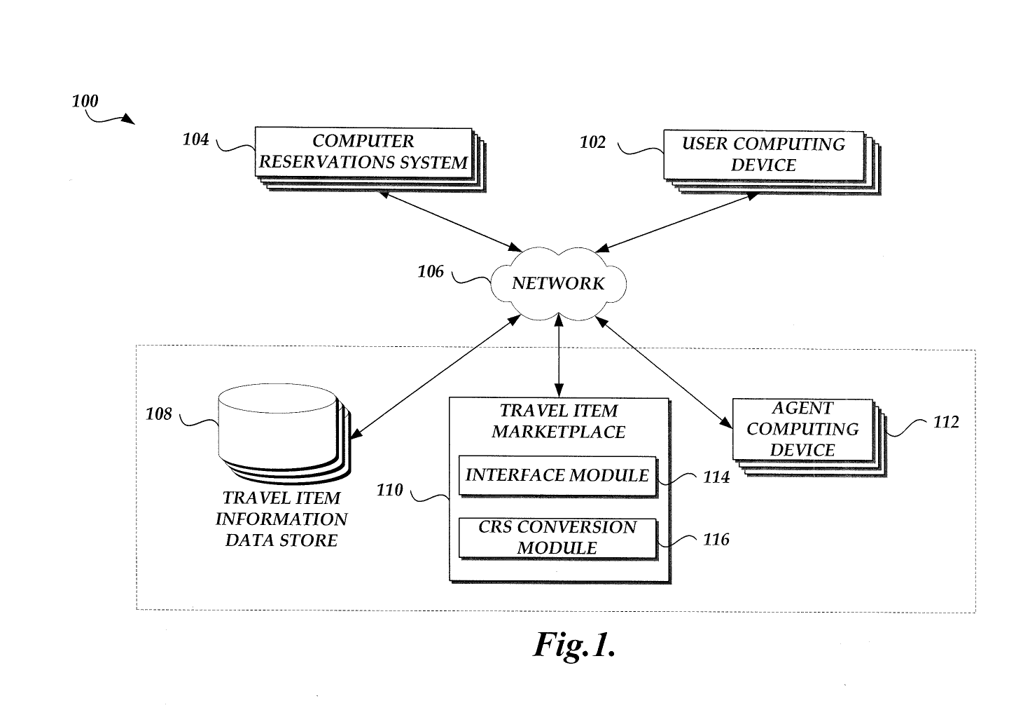

FIG. 1 is a block diagram illustrating an embodiment of a networked computing environment 100 including a travel item marketplace 110 for automatic conversion of encoded travel data and presentation of human-readable travel information through chat interfaces. The network environment 100 includes one or more user computing devices 102, one or more Computer Reservation Systems 104, the travel item marketplace 110, one or more travel item information data stores 108, and one or more agent computing devices 112. Illustratively, components of the networked computing environment 100 are communicatively interconnected with one another via a network 106. The networked computing environment 100 may include different components, a greater or fewer number of components, and can be structured differently. For example, there can be more data stores or other computing devices in connection with the travel item marketplace 110. As another example, components of the networked computing environment 100 may communicate with one another without going through the network 106. Illustratively, the travel item marketplace 110 may be in direct data communication with the one or more travel item information data stores 108.

The user computing devices 102 can be any user computing devices capable of interacting with the communication management server 110 (e.g., to display human-readable travel information from within a chat interface). For example, the user computing devices 102 may be an electronic device, such as a laptop or tablet computer, personal computer, personal digital assistant (PDA), hybrid PDA/mobile phone, mobile phone, global positioning system (GPS) device, electronic book reader, set-top box, camera, clock, watch, audiobook player, digital media player, video game console, in-store kiosk, television, one or more processors, integrated components for inclusion in computing devices, appliances, electronic devices for inclusion in vehicles or machinery, gaming devices, or the like.

The Computer Reservation Systems 104 can be any systems, services, or data stores that can provide encoded travel data. Individual Computer Reservation Systems 104 may determine their respective data encoding formats independently, and may not be subject to control of or otherwise associated with the travel item market place 110 or with the travel item information data stores 108. The Computer Reservation Systems 104 may support query and retrieval of information supplied by multiple travel item providers, such as airlines, hotels, car rental agencies, cruise lines, bus services, etc., thereby making travel items available for booking, reservation, and/or purchase. For example, the Computer Reservation Systems 104 may include Global Distribution Systems (GDS) that provide ticketing information for multiple airlines. The Computer Reservation Systems 104 may also include independent reservation systems that do not participate in or contribute to GDSs or other centralized systems. For example, a Computer Reservation System 104 may correspond to a system provided by an individual travel item provider (e.g., a specific airline, hotel or hotel chain, car rental agency, cruise line, bus service, etc.).

The network 106 may include any suitable combination of networking hardware and protocols necessary to establish communications within the networked computing environment 100. For example, the network 106 may include private networks such as local area networks (LANs) or wide area networks (WANs) as well as public or private wireless networks, satellite networks, cable networks, cellular networks, or the Internet. In such an embodiment, the network 106 may include hardware (e.g., modems, routers, switches, load balancers, proxy servers, etc.) and software (e.g., protocol stacks, accounting software, firewall/security software, etc.) that establish networking links within the networked computing environment 100. Additionally, the network 106 may implement one of various communication protocols for transmitting data between components of the networked computing environment 100.

The travel item information data stores 108 can generally include any repository, database, or information storage system. Alternatively, or in addition, a travel item information data store 108 can be a data service or interface, which provides data upon request. The travel item information data stores 108 can store any information relevant to travel items. For example, the travel item information data stores 108 may include specific information regarding flights, such as departure/arrival airports, departure/arrival times, operating airlines, aircraft models, cabin/class configurations, seating availability and maps, in-flight services, fare-related policy, cancellation policy, baggage policy, reviews or ratings regarding various attributes of the flights or airlines, combinable or add-on travel items, etc. The travel item information data stores 108 may also include corresponding information regarding hotel rooms, such as hotel descriptions, photos, traveler reviews, amenity information, map information, etc. The travel item information data store 108 may further include corresponding information regarding rental cars, tours, or other travel activities. In some embodiments, at least some information included in the travel item information data stores 108 cannot be represented by or derived from encoded CRS data provided by Computer Reservation Systems 104.

The travel item marketplace 110 may be implemented by one or more computing devices. For example, the travel item marketplace 110 may be implemented by computing devices that include one or more processors to execute one or more instructions, memory, and communication devices to transmit and receive data over the network 106. In some embodiments, the travel item marketplace 110 is implemented on one or more backend servers capable of communicating over a network. In other embodiments, the travel item marketplace 110 is implemented by one or more virtual machines in a hosted computing environment, e.g., a “Cloud” computing environment. The hosted computing environment may include one or more provisioned and released computing resources, which computing resources may include computing, networking or storage devices.

Illustratively, the travel item marketplace 110 may include an interface module 114 and a CRS conversion module 116. The interface module 114 may facilitate or accomplish generation of appropriate interfaces on user computing devices 102 or agent computing devices 112, through which users or agents are enabled to transmit data to and from the travel item marketplace 110. In some embodiments, the interface module 114 may include a server for generation of webpages or application windows facilitating inputting, reviewing, or otherwise interacting with travel item related data or information. Additionally, the interface module 114 may communicate with the CRS conversion module 116 for transmitting encoded CRS data, travel information data objects, bookable travel reservation data, etc. The CRS conversion module 116 may facilitate or accomplish analysis of encoded CRS-formatted data, retrieval of relevant travel items and information from the one or more travel item information data stores 108, generation of travel information data object based on the analysis of CRS-formatted data and retrieved travel items, generation of human-readable travel information and associated user interface based on the travel information data object, or other relevant functions disclosed herein.

The agent computing devices 112 can be any physical computing devices associated with users. For example, the agent computing devices 112 may be an electronic device, such as a laptop or tablet computer, personal computer, personal digital assistant (PDA), hybrid PDA/mobile phone, mobile phone, global positioning system (GPS) device, electronic book reader, set-top box, camera, clock, watch, audiobook player, digital media player, video game console, in-store kiosk, television, one or more processors, integrated components for inclusion in computing devices, appliances, electronic devices for inclusion in vehicles or machinery, gaming devices, or the like.

By use of the relevant components of the networked environment 100 as described above, illustratively an electronic travel item marketplace may receive travel data encoded in CRS format from a travel agent via an agent chat interface. The electronic travel item market place may identify and retrieve available travel items based on information derived from the encoded travel data. The electronic travel item marketplace may generate human-readable travel information corresponding to the travel items for presentation to a user via a user chat interface. The electronic travel item marketplace may further present a representation of the human-readable travel information to the user, which enables direct booking the travel items.

One skilled in the relevant art will appreciate that the components and configurations provided in FIG. 1 are illustrative in nature. Accordingly, additional or alternative components and/or configurations, especially regarding the additional components, systems and subsystems for facilitating functions disclosed herein may be utilized.

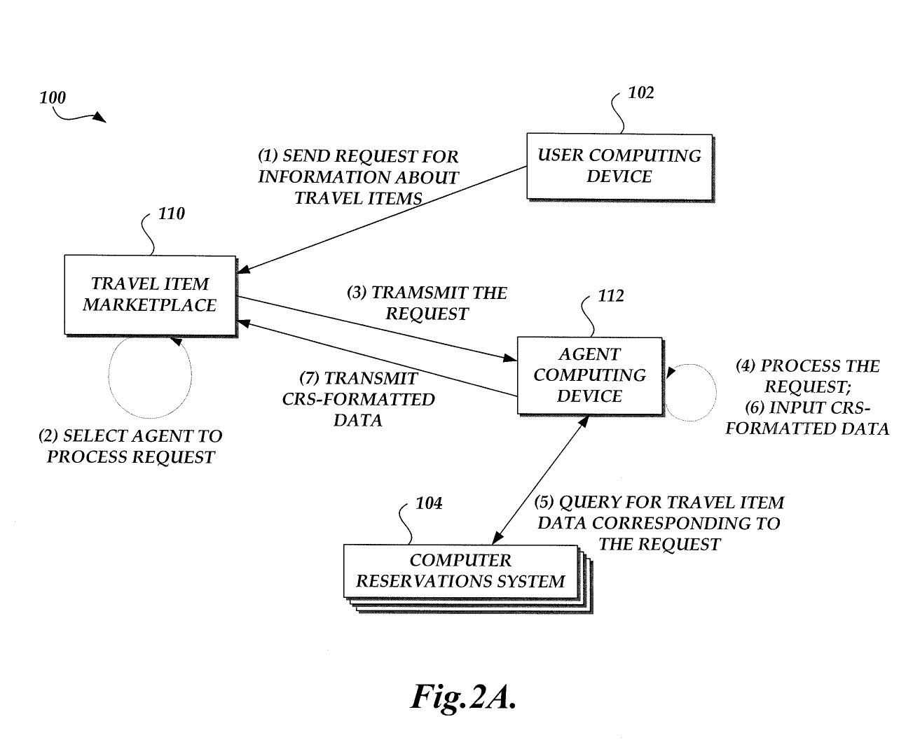

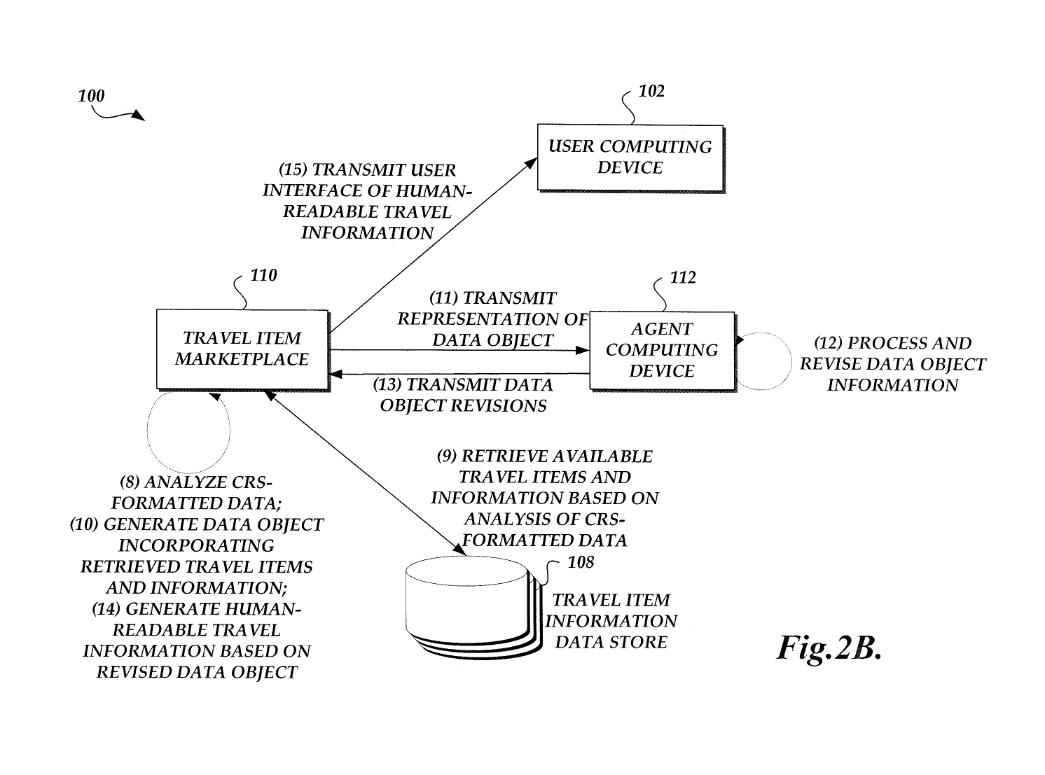

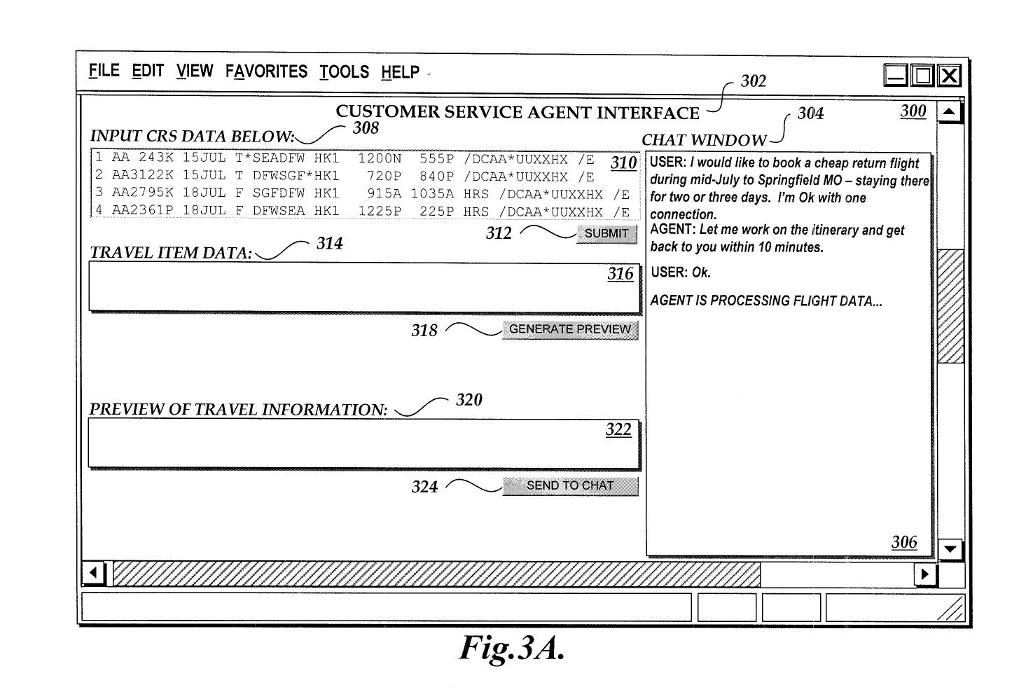

FIGS. 2A and 2B are simplified block diagrams illustrating interactions among components of the networked computing environment 100 of FIG. 1 for presenting to a user human-readable travel information generated based on automatic processing of CRS-formatted travel data. With reference to FIG. 2A, at (1), a user computing device 102 may submit a request for information regarding available travel items via a network-based chat interface to the travel item marketplace 110. For example, the request may include criteria for time or location of one or more travel items desired by a user utilizing the user computing device 102. As another example, the request may include a description of changes to the user's current travel schedule. In some embodiments, the request may correspond to a request for information regarding flights, hotels, cars, cruises, travel packages, etc. In other embodiments, the request may ask for travel item recommendations without specifying the type or category of travel items desired. Further, the request may correspond to a textual description, audio or video file, other multimedia formats, or any form of expression supported by the network-based chat interface.

At (2), the travel item marketplace 110 selects a travel agent to process the t request. The travel item marketplace 110 can select the travel agent based on availability or specialty of the agent, business relationship between the user and the agent, or other factors. For example, the travel item marketplace 110 may select an agent familiar with the type of travel items corresponding to the request. As another example, the travel item marketplace 110 may select an agent who previously handled a related travel transaction for the user. As a further example, the travel item marketplace 110 may select an agent because the agent has a travel booking service agreement with a business group to which the user belongs. At (3), the travel item marketplace 110 then transmits the request to an agent computing device 112 associated with the selected agent. In some embodiment, the travel item marketplace 110 may also transmit metadata associated with the request to the agent computing device 112. The metadata may include information related to the user computing device 110, such as a network address or geolocation associated with the requesting device 110.

At (4), the agent computing device 112 processes the request. The agent computing device 112 may perform applicable data format conversions to the request and present the request to the agent in a format supported by an agent chat interface. For example, the agent computing device 112 may display textual portions of the request in a different font or with different paragraph spacing than the user's original request input. As another example, the agent computing device 112 may transcribe an audio request and present a corresponding textual request to the agent. In some embodiments, the agent computing device 112 may identify and retrieve additional user information related to the requesting user. For example, the agent computing device 112 may retrieve user demographic or travel-related data from a user profile data store (not shown). The additional user information may be combined with the request to assist the travel agent's search for travel items that match the request.

At (5), the agent computing device 112 queries one or more CRS systems for travel item data corresponding to the request. Illustratively, the travel agent may review the request as presented via the agent chat interface and determine corresponding queries to the one or more CRS systems. In some embodiments, the queries can be automatically or semi-automatically generated by the agent computing device 112. For example, various Natural Language Processing (NLP) methods can be employed by the agent computing device 112 to analyze the request and derive pertinent query criteria. The travel agent may use one or more CRS interfaces or applications separate from the agent chat interface to submit the queries to or otherwise interact with the CRS systems. In response to the agent queries, the one or more CRS systems return corresponding travel item data in encoded CRS format to the agent computing device 112. The encoded CRS-formatted data may or may not be returned via the agent chat interface where the request is presented. An example of returned encoded CRS-formatted data corresponding to a flight itinerary is as follows:

| | | | | | | |
|---|---|---|---|---|---|---|
| 1 | AA 243K | 15JUL | T*SEADFW HK1 | 1200N | 555P | /DCAA*UUXXHX /E |
| 2 | AA3122K | 15JUL | T DFWSGF*HK1 | 720P | 840P | /DCAA*UUXXHX /E |
| 3 | AA2795K | 18JUL | F SGFDFW HK1 | 915A | 1035A | HRS /DCAA*UUXXHX /E |
| 4 | AA2361P | 18JUL | F DFWSEA HK1 | 1225P | 225P | HRS /DCAA*UUXXHX /E |

The example of CRS-formatted data above provides information about a flight itinerary including four legs, but is not readily readable to laypersons. In the example shown above, each line of CRS-formatted data (numbered 1 through 4) corresponds to a leg of an itinerary. Each line of data has multiple fields (e.g., columns) of information, for example, as separated by white spaces. These fields present encoded information regarding the flight itinerary. Specifically, in the example above, each line of CRS-formatted data represents a segment number, an airline, a flight number, a booking class, a date, a day of week, a departure and arrival city, a segment status, a departure time, a connectivity type, and an indication of electronic ticketing support. CRS-formatted data may also provide information regarding fare and tax, baggage policy, etc. One example of CRS-formatted baggage policy data is below.

| | |
|---|---|
| BAG ALLOWANCE | -SEASGF-NIL/AA |

1STCHECKED BAG FEE-SEASGF-USD25.00/AA/UP TO 50 POUNDS/23 KILOGR
AMS AND UP TO 62 LINEAR INCHES/158 LINEAR CENTIMETERS
2NDCHECKED BAG FEE-SEASGF-USD35.00/AA/UP TO 50 POUNDS/23 KILOGR
AMS AND UP TO 62 LINEAR INCHES/158 LINEAR CENTIMETERS

| | |
|---|---|
| BAG ALLOWANCE | -SGFSEA-03P/AA/EACH PIECE UP TO 70 POUNDS/32 |

KILOGRAMS AND UP TO 62 LINEAR INCHES/158 LINEAR CENTIMETERS

Specifically, the CRS-formatted data above notes that a first checked bag of up to 50 pounds and up to 62 inches long between Seattle, Wash. and Springfield, Mich. costs $25 USD and that a second checked bag (with the same restrictions) would cost $35 USD. The CRS-formatted data further indicates that three pieces of luggage are allowed when traveling from Springfield, Mich. to Seattle, Wash., and that each pieces is associated with specific weight and length restrictions. While a skilled agent may be able to derive such information from the CRS-formatted data, a typical user may be unable to do so. Accordingly, it may be preferable to utilize the CRS-formatted data to display human-readable travel information to the user, as described below.

As noted above, the agent queries may be partially based on the additional user information. For example, the request to book a second-day flight may specify an arrival city or airport but not a departure location. The agent computing device 112 may identify or derive departure information from the retrieved additional user information. Illustratively, the retrieved additional user information may indicate that the user is currently on business trip to city A based on the user's recent travel transaction records. Accordingly, city A can be considered the departure location. Alternatively or in addition, relevant departure location can be derived or confirmed from the metadata associated with the request. For example, the metadata associated with the request may indicate that the request was transmitted from an IP address corresponding to a geographic area that covers city A.

At (6), the travel agent may input at least some part of the returned encoded CRS-formatted data into the agent chat interface presented on the agent computing device 112. As noted above, in some embodiments, a standalone CRS application may return the encoded CRS-formatted data to the agent computing device 112. In accordance with these embodiments, the travel agent may select and copy at least some part of the returned encoded CRS-formatted data from the standalone CRS application, and paste the selected data to the agent chat interface. In other embodiments, a CRS application integrated with the agent chat interface may return encoded CRS-formatted data to the agent computing device 112. In accordance with these embodiments, at least some part of the returned encoded CRS data may be automatically or semi-automatically transmitted from the CRS application into the agent chat interface, with or without further interactions by the travel agent. At (7), the agent computing device 112 transmits the inputted encoded CRS-format data to the travel item marketplace 110. In some embodiments, the additional user information may also be transmitted to the travel item marketplace 110.

Now with reference to FIG. 2B, at (8), the travel item marketplace 110 analyzes the encoded CRS-formatted data. In some embodiments, the travel item marketplace 110 may parse the encoded CRS-formatted data and extract information that contributes to identification of relevant travel items. Regular expression, keyword, spacing or delimitation based parsing methods can be employed to determine the travel item identifying information. In a context of encoded CRS-formatted data corresponding to flights, the travel item identifying information may include departure/arrival times and locations, flight numbers, class information, etc. In some embodiments, the travel item marketplace 110 may not be able to extract sufficient travel item identifying information for various reasons. For example, the travel agent may have neglected to copy a row or column of encoded CRS-formatted data. In these embodiments, the travel item marketplace 110 may send an error message to the agent computing device 112. Alternatively or in addition, the travel item marketplace 110 may request for and obtain agent input of missing information through the agent chat interface. For example, the agent may be prompted to input flight identifying information, such as a departure time, for a leg of a flight itinerary.

At (9), the travel item marketplace 110 retrieves available travel items and corresponding information from one or more travel item information data stores 108 based on the analysis of the encoded CRS-formatted data. In some embodiments, searches can be performed on the one or more data stores 108 using the extracted travel item identifying information. In response to the searches, corresponding travel items such as flights, hotel rooms, rental cars, tours, or other travel activities can be identified and retrieved. Additionally, various policies, attributes, relationships, business logic, or other information corresponding to the identified travel items or their combination can be identified and retrieved. Further, the searches can be modified, enhanced or filtered by the additional user information. For example, the additional user information may indicate that the user only flies business class, always requires a rental car at some specified airports, or has a spending limit on the cost of flights for some specified routes.

At (10), the travel item marketplace 110 generates one or more travel information data objects each corresponding to an identified travel item or a combination of identified travel items. The travel information data objects may include corresponding travel item information retrieved from the one or more travel item information data stores 108 as well as information directly derived from the encoded CRS-formatted data. In some embodiments, the travel item marketplace 110 performs additional processing steps on the corresponding travel item information. For example, the cost or price of a retrieved travel item may need to be adjusted based on retrieved policies applicable to the user, a combination of travel items, any unused portion of previous travel bookings, or the like. In other embodiments, inconsistencies or errors may occur when various travel item information are processed, integrated, and incorporated into the travel information data object. In accordance with these embodiments, the travel item marketplace 110 may request for and obtain agent input or instructions. For example, if conflicting or ambiguous fare modification policies are retrieved, the travel agent may be prompted via the agent chat interface to select a policy or indicate a priority among applicable policies.

At (11), the travel item marketplace 110 transmits a representation of the one or more travel information data objects to the agent computing device 112. In some embodiments, the representation includes a user-friendly structure, such as a multi-layered tree structure, that organizes information included in the data object. At (12), the agent computing device processes the representation of the one or more data objects to enable submission of revisions to the data objects. The representation of the one or more data objects may be presented via the agent chat interface for review by the agent. The travel agent may input revisions to information included in the data object by interacting with the presented data. For example, the representation of the travel information data object may be presented in an editable text format or be associated with selectable check boxes. The travel agent may submit revisions to correct errors, provide supplemental information, rewrite or reorganize information, or select information to be presented to the user.

At (13), the agent computing device 112 transmits revisions to the one or more travel information data objects to the travel item marketplace 110. At (14), the travel item marketplace 110 applies the revisions, modifies the one or more travel information data objects, and generates human-readable travel information based on the modified data objects. The human-readable travel information may include travel item information selected by the travel agent in accordance with the revisions. The human-readable travel information may be associated with processing instructions or logic for receiving the user's potential acceptance and for performing actual booking of the travel items corresponding to the human-readable travel information. For example, the travel item marketplace 110 may generate associated human-readable instructions which may specify steps (e.g. adjusting relevant travel item inventory, sending confirmation message, etc.) the travel agent should take to book the reservation once accepted by the user. As another example, the travel item marketplace 110 may generate instructions executable by a computing device associated with the travel item marketplace 110 for automatic completion of the booking of corresponding travel items.

At (15), the travel item marketplace 110 generates and transmits a user interface of the human-readable travel information to the user computing device 102. The user interface can be presented to the user in the network-based chat interface where the user originally submitted the request. The user interface of the human-readable travel information may include a representation of the human-readable travel information as well as one or more interactive areas or icons that enable the user to accept and book travel items corresponding to the presented travel information. For example, the user may click on such an area or icon, which causes the corresponding travel items to be automatically processed or manually booked by the travel agent based on the associated processing instructions or logic described earlier. In some embodiments, the one or more interactive areas of icons may enable the user to view additional information about the corresponding travel items.

In some embodiments, a preview of the user interface is transmitted to the agent computing device 112 for the agent's review prior to its transmission to the user computing device 102. In accordance with these embodiments, the travel agent may submit additional revisions to the corresponding travel information data object(s) and may be presented with additional previews of the consequently revised human-readable travel information.

Using of relevant interactions as described above, illustratively a travel agent may retrieve travel data encoded in CRS format and transmit the encoded travel data via an agent chat interface to an electronic travel item marketplace. The electronic travel item market place may identify and retrieve available travel items based on information derived from the encoded travel data. The electronic travel item marketplace may generate human-readable travel information corresponding to the travel items for presentation to a user via a user chat interface. The electronic travel item marketplace may further present a representation of the human-readable travel information to the user, which enables direct booking the travel items.

### An Example Embodiment of Agent Chat Interface

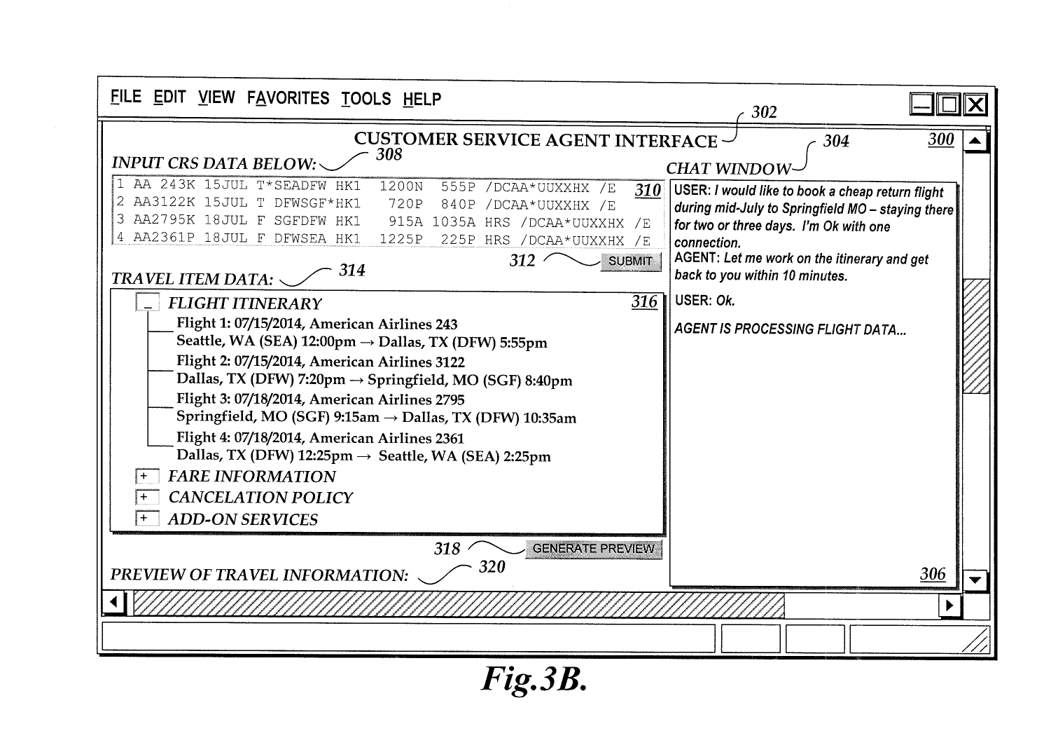

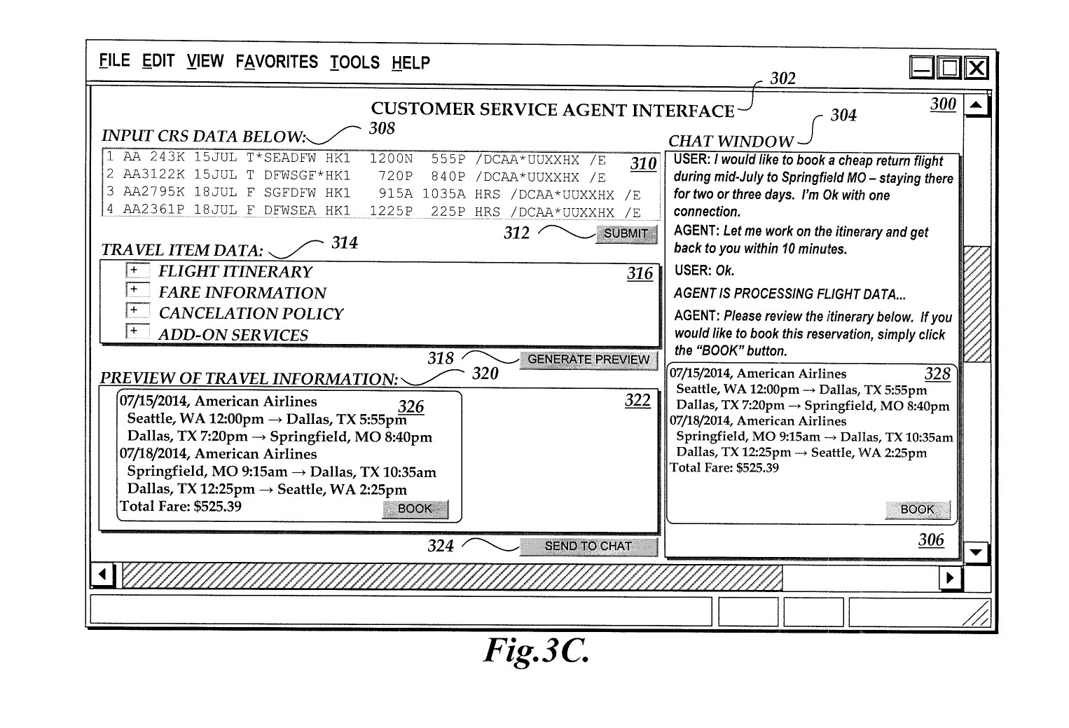

FIGS. 3A-C depict illustrative user interfaces displayed on an agent computing device 112 of FIG. 1 and used by a travel agent to automatically process CRS-formatted travel data and generate human-readable travel information for presentation to a user computing device 102 of the networked computing environment of FIG. 1. With reference to FIG. 3A, an agent chat interface 300 enables a travel agent to chat with a user, to input encoded CRS-formatted data, to revise travel information data object, to preview user interface of corresponding human-readable travel information, and to cause presentation of the user interface to the user. Illustratively, the agent chat interface 300 may be generated by the interface module 114 and presented on the agent computing device 112 by an application, such as a browser application, on the agent computing device 112. Illustratively, the agent chat interface 300 contains a title 302, i.e., the “Customer Service Agent Interface.” In accordance with this embodiment, the agent chat interface 300 includes four functional sections identified by subtitle 304 “Chat Window,” subtitle 308 “Input CRS Data Below,” subtitle 314 “Travel Item Data” and subtitle 320 “Preview of Travel Information.”

A first functional section corresponding to subtitle 304 “Chat Window” includes an interactive portion 306. The interactive portion 306 may facilitate text-based chatting between a user and a travel agent utilizing the agent chat interface 300. For example, the interactive portion 306 may display the user's request, such as the “I would like to book a cheap return flight during mid-July to Springfield Mo.—staying there for two or three days. I'm Ok with one connection.” shown in FIG. 3A. The interactive portion 306 may also display other user inputs as well as accepting and displaying input from the travel agent. The interactive portion 306 may further display information regarding other actions taken by the travel agent, such as the “Agent is processing flight data . . . ” as shown in FIG. 3A.

A second functional section corresponding to subtitle 308 “Input CRS Data Below” includes a text input portion 310 and a button 312. The travel agent may input, such as by pasting, encoded CRS-formatted data corresponding to the user's request into the text input portion 310. In the example shown by FIG. 3A, four lines of flight data in encoded CRS format are pasted into the text input portion 310. By clicking the button 312, the travel agent may cause the inputted data to be transmitted to the travel item marketplace 110 for analysis and subsequent processing.

A third functional section corresponding to subtitle 314 “Travel Item Data” includes an editable display area 316 and a button 318. The editable display area 316 may display a representation of one or more travel information data objects generated by the travel item marketplace 110 based on the encoded CRS-formatted data inputted through the text input portion 310. With reference now to FIG. 3B, the editable display area 316 displays a layered tree representation of human-readable flight reservation information in accordance with the four lines of encoded CRS-formatted data inputted through the text input portion 310. As described earlier, information displayed in the editable display area 316 can be edited, supplemented, removed, selected, or otherwise revised in accordance with functionalities supported by the agent chat interface 300 or the editable display area 316. With applicable modifications to the information displayed, the travel agent may click the button 318 to submit the corresponding revisions to the travel item marketplace 110 for generation of human-readable travel information to be presented to the user based thereon.

With reference to FIG. 3C, a fourth functional section corresponding to subtitle 320 “Preview of Travel Information” includes a display area 322 and a button 324. The display area 322 may display a preview of a user interface of the human-readable travel information generated based on the revised one or more travel information data objects. As shown in FIG. 3C, illustratively, a preview representation 326 of a user interface for a bookable return flight itinerary is displayed in the display area 322. Upon clicking the button 324, the travel agent notifies the travel item marketplace 110 to transmit the user interface of the return flight itinerary to the user computing device 102. Simultaneously, a representation of the user interface is also displayed in the interactive portion 306.

Using the interfaces as illustrated in FIG. 3A-3C, a travel agent may input retrieve travel data encoded in CRS format and transmit the encoded travel data to an electronic travel item marketplace. The travel agent may then be presented with human-readable information regarding available travel items related to the encode travel data as determined by the electronic travel item marketplace. Upon review and revision of the presented information, the travel agent may cause a representation of the human-readable information to be presented to a user.

It should be noted that there may be a fewer or greater number of functional sections included in the agent chat interface 300, which facilitate different functionalities or their combinations as disclosed herein. For example, in some embodiments, the agent chat interface 300 merely includes an interactive portion 306, which may accept encoded CRS-formatted data and automatically display a representation of human-readable travel information corresponding to the encoded CRS-formatted data. In accordance with these embodiments, the interactive portion 306 may optionally display various intervening states of corresponding information, such as corresponding travel information data objects, and optionally accept applicable revisions before presenting the human-readable travel information.

### An Example Embodiment of User Chat Interface

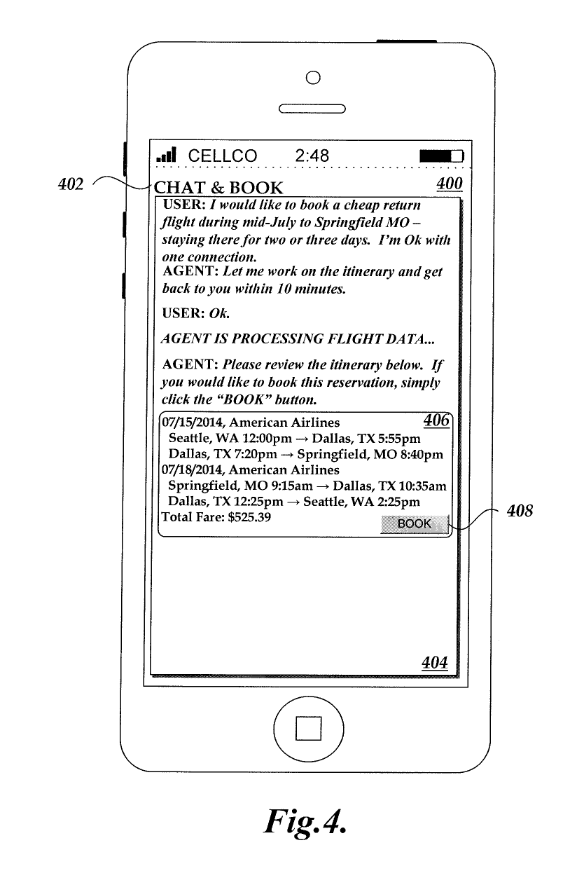

FIG. 4 depicts an illustrative user interface displayed by a user computing device 102 of FIG. 1 and enabling a user to view and interact with human-readable travel information generated based on processed CRS-formatted travel data. With reference to FIG. 4, a network-based chat interface 400 enables a user to chat with a travel agent, to view user interfaces of human-readable travel information, and to book desired travel items corresponding to the human-readable travel information. Illustratively, the network-based chat interface 400 may be generated by the interface module 114 and presented on the user computing device 102 by an application, such as a browser application, on the user computing device 102. Illustratively, the user chat interface 400 contains a title 402, i.e., the “Chat & Book.”

In accordance with this embodiment, the network-based chat interface 400 includes an interactive portion 404. The interactive portion 404 may facilitate text-based chatting between a user utilizing the network-based chat interface 400 and a travel agent. For example, the interactive portion 404 may accept and display the user's request, such as the “I would like to book a cheap return flight during mid-July to Springfield Mo.—staying there for two or three days. I'm Ok with one connection.” as shown in FIG. 4. The interactive portion 406 may also accept and display other user inputs as well as display input from the travel agent. The interactive portion 404 may further display information regarding other actions taken by the travel agent, such as the “Agent is processing flight data . . . ” as shown in FIG. 4.

Still further, the interactive portion 406 may display one or more user interfaces of human-readable travel information generated from encoded CRS-formatted data. As shown in FIG. 4, illustratively, a user interface 406 of a human-readable flight itinerary is presented in the interactive portion 404. The user interface 406 may further include a button 408. As described earlier, clicking the button 408 may cause a computing device associated with the travel item marketplace 110 to execute corresponding instructions to book flight tickets corresponding to the itinerary. Alternatively, clicking the button 408 may cause human-readable instructions to be presented to the travel agent, who may take proper steps as instructed to complete the flight ticket booking.

Using the interface as illustrated in FIG. 4, a user may be presented with a representation of human-readable information corresponding to travel items available through an electronic travel item marketplace. The user may further complete booking of the travel items by interacting with the presentation of the human-readable information.

### An Example Embodiment of Travel Data Processing Routine

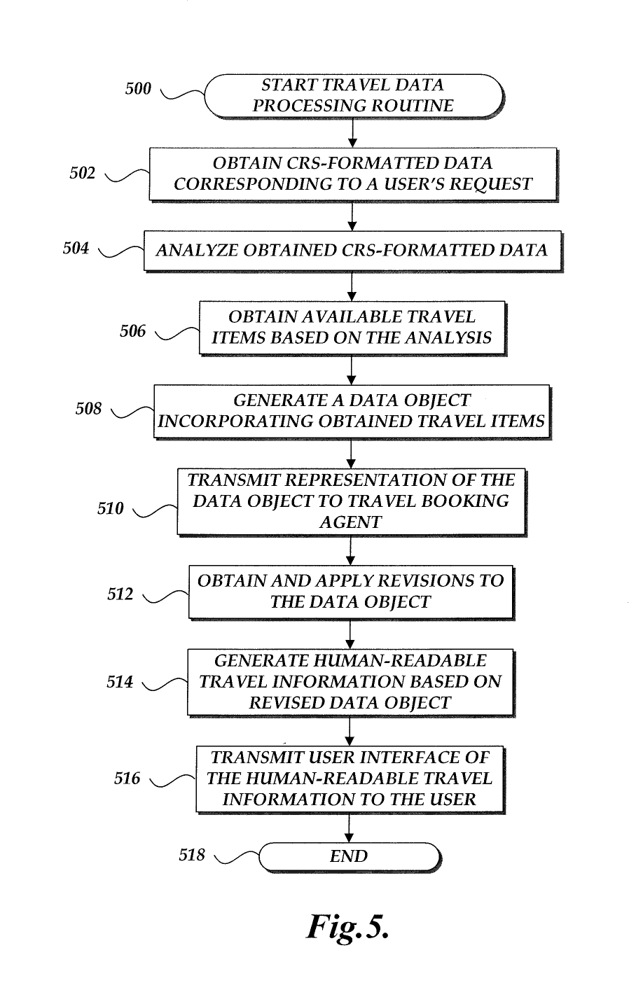

FIG. 5 is a flow diagram illustrating an embodiment of a travel data processing routine implemented by the travel item marketplace 110 of FIG. 1 to automatically process CRS-formatted travel data and generate human-readable travel information for presentation to a user. At block 502, the travel item marketplace 110 obtains encoded CRS-formatted data corresponding to a user's request for information regarding available travel items. As described earlier, the encoded CRS data may be derived from query results generated by one or more CRS systems for travel item data corresponding to the request. In some embodiments, additional user information may also be obtained by the travel item marketplace 110.

At block 504, the travel item marketplace 110 analyzes the encoded CRS-formatted data. In some embodiments, the travel item marketplace 110 may parse the encoded CRS-formatted data and extract information that contributes to identification of relevant travel items. The travel item marketplace 110 may employ regular expression, keyword, spacing and delimitation based parsing methods to determine the travel item identifying information. In a context of encoded CRS-formatted data corresponding to flights, the travel item identifying information that can be determined may include departure/arrival times and locations, flight numbers, class information, etc. For example, the travel item marketplace may establish a number of templates to match various CRS formats. One of the templates may indicate that each line of text starting with a numerical value stands for a leg of flight. The travel item marketplace may also utilize a dictionary or list that maps acronyms or codes (e.g., 3-letter codes for airports) to their human-readable description, to match to any encoded text flanked by white spaces. Alternatively or in addition, the travel item marketplace 110 may request for and obtain input of supplemental or missing information from a travel agent.

At block 506, the travel item marketplace 110 obtains available travel items and corresponding information from one or more travel item information data stores 108 based on the analysis of the encoded CRS-formatted data. In some embodiments, the travel item marketplace may perform searches on the one or more data stores 108 using the extracted travel item identifying information. In response to the searches, the travel item marketplace 110 may identify and retrieve corresponding travel items that are available for booking through the travel item marketplace 110, such as flights, hotel rooms, rental cars, tours, or other travel activities. In other embodiments, the travel item marketplace may review existing search results including the extracted travel item identifying information and retrieve available travel items included in the search results. Additionally, the travel item marketplace 110 may identify and retrieve various policies, attributes, relationships, business logic, or other information corresponding to the identified travel items or their combination. Further, the travel item marketplace 110 may modify, enhance or filter the searches with the additional user information. For example, the additional user information may indicate that the user only flies business class, always requires a rental car at some specified airports, or has a spending limit on flights for some specified routes.

At block 508, the travel item marketplace 110 generates one or more travel information data objects each corresponding to an identified travel item or a combination of identified travel items. The travel information data objects may include corresponding travel item information retrieved from the one or more travel item information data stores 108 as well as information directly derived from the encoded CRS-formatted data. In some embodiments, the travel item marketplace 110 performs additional processing steps on the corresponding travel item information. For example, the cost or price of retrieved travel items may need to be adjusted based on retrieved policies applicable to the user, a combination of travel items, any unused portion of previous travel bookings, or the like. In other embodiments, inconsistencies or errors may occur when various travel item information are processed, integrated, and incorporated into the travel information data object. In accordance with these embodiments, the travel item marketplace 110 may request for and obtain input or instructions from a travel agent. For example, if conflicting or ambiguous fare modification policies are retrieved, the travel agent may be prompted to select a policy or indicate a priority among applicable policies.

At block 510, the travel item marketplace 110 transmits a representation of the one or more travel information data objects to an agent computing device 112 associated with a travel agent. In some embodiments, the representation includes a user-friendly structure, such as a multi-layered tree structure, that organizes information included in the data object. At block 512, the travel item marketplace 110 obtains revisions to information included in the data object. For example, the representation of the travel information data object may be presented to the travel agent in an editable text format or be associated with selectable check boxes. The travel agent may thereby submit revisions to correct errors, provide supplemental information, rewrite or reorganize information, select information to be presented to the user. The agent computing device 112 may subsequently transmit revisions to the one or more travel information data objects to the travel item marketplace 110. Thereafter, the travel item marketplace 110 applies the revisions and modifies the one or more travel information data objects accordingly.

At block 514, the travel item marketplace 110 generates human-readable travel information based on the revised travel information data objects. The human-readable travel information may include travel item information selected by the travel agent in accordance with the revisions. The human-readable travel information may also be associated with processing instructions or logic for receiving the user's potential acceptance and for performing actual booking of the travel items corresponding to the travel information. For example, the travel item marketplace 110 may generate human-readable instructions which may specify steps (e.g. adjusting relevant travel item inventory, sending confirmation message, etc.) the travel agent should take to book the corresponding travel items once accepted by the user. As another example, the travel item marketplace 110 may generate instructions executable by a computing device associated with the travel item marketplace 110 for automatically completing the booking.

At block 516, the travel item marketplace 110 generates and transmits a user interface of the human-readable travel information to a user computing device 102 associated with the user. The user interface can be presented to the user in a user chat interface where the user originally submitted the request. The user interface of the human-readable travel information may include one or more interactive areas or icons for the user to accept and book travel items corresponding to the presented travel information. In some embodiments, the one or more interactive areas of icons may enable the user to view additional information regarding the corresponding travel items. The routine of FIG. 5 ends at block 518.

Depending on the embodiment, certain acts, events, or functions of any of the methods described herein can be performed in a different sequence, can be added, merged, or left out altogether (e.g., not all described acts or events are necessary for the practice of the algorithm). Moreover, in certain embodiments, acts or events can be performed concurrently, e.g., through multi-threaded processing, interrupt processing, or multiple processors or processor cores or on other parallel architectures, rather than sequentially.

The various illustrative logical blocks, modules and method elements described in connection with the embodiments disclosed herein can be implemented as electronic hardware, computer software or combinations of both. To clearly illustrate this interchangeability of hardware and software, various illustrative components, blocks, modules and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The elements of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM or any other form of computer-readable storage medium known in the art. A storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Conditional language used herein, such as, among others, “can,” “might,” “may,” “e.g.” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” “involving” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some or all of the elements in the list.

Disjunctive language such as the phrase “at least one of X, Y or Z,” unless specifically stated otherwise, is otherwise understood with the context as used in general to present that an item, term, etc., may be either X, Y or Z, or any combination thereof (e.g., X, Y and/or Z). Thus, such disjunctive language is not generally intended to, and should not, imply that certain embodiments require at least one of X, at least one of Y or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments described herein can be embodied within a form that does not provide all of the features and benefits set forth herein, as some features can be used or practiced separately from others. All changes which come within the meaning and range of equivalency of the claims are to be embraced within their scope.

What is claimed is:

1. A computer-implemented method for facilitating travel booking, the computer-implemented method comprising:
under control of a hardware computing device configured with specific computer executable instructions,
obtaining, from a computing device of a travel agent, travel data encoded in accordance with a Computer Reservations System (CRS) format, wherein the encoded travel data is retrieved from a CRS based at least in part on a user's request for travel item information;
extracting, from the encoded travel data, information identifying a travel item available from an electronic travel item marketplace;
determining a set of human-readable information regarding the travel item based at least in part on information retrieved from the electronic travel item marketplace, wherein the set of human-readable information includes information not present within the encoded travel data;
transmitting, to the computing device of the user, instructions to generate a user interface regarding the travel item, the user interface comprising at least the set of human-readable information regarding the travel item and an input enabling the user to book the travel item on the electronic travel item marketplace; and
automatically booking the travel item in response to user selection of the input, wherein automatically booking the travel item does not require further action by the travel agent.

2. The computer-implemented method of claim 1 further comprising
transmitting the set of human-readable information regarding the travel item to the computing device of the travel agent;
obtaining instructions from the travel agent regarding presentation of the set of human-readable information regarding the travel item on a computing device of the user.

3. The computer-implemented method of claim 1, wherein the encoded travel data comprises data received from a Global Distribution System (GDS).

4. The computer-implemented method of claim 1, wherein the set of human-readable information regarding the travel item includes the extracted information identifying the travel item.

5. The computer-implemented method of claim 1 further comprising obtaining supplemental information from travel agent, wherein the supplemental information cannot be derived from the encoded travel data and further defines the travel item and wherein the set of human-readable information regarding the travel item is determined based at least in part on the supplemental information.

6. A computer-implemented method comprising:
under control of a hardware computing device configured with specific computer executable instructions,
obtaining, from a computing device of a travel agent, encoded CRS travel data corresponding to a request for travel item information;
determining a set of human-readable information regarding a travel item identified from an electronic travel item marketplace in accordance with information derived from the encoded CRS travel data;
transmitting instructions to generate a user interface regarding the travel item, the user-interface comprising at least the set of human-readable information regarding the travel item and an input enabling a user to book the travel item on the electronic travel item marketplace; and
automatically booking the travel item in response to the user's election of the input.

7. The computer-implemented method of claim 6 further comprising obtaining at least one revision to the set of human-readable information.

8. The computer-implemented method of claim 7, wherein the obtained at least one revision indicates a selection of information to be presented to the user.

9. The computer-implemented method of claim 7, wherein the user interface regarding the travel item is generated in accordance with the obtained at least one revision.

10. The computer-implemented method of claim 6 further comprising causing presentation of the user interface regarding the travel item in a text-based chat environment.

11. A system comprising:
a data store configured to at least store computer-executable instructions; and
a hardware processor in communication with the data store, the hardware processor configured to execute the computer-executable instructions to at least:
obtain, from a computing device of a travel agent, encoded CRS travel data of travel reservation corresponding to a request for travel item information;
determine a set of human-readable information regarding a travel item identified from an electronic travel item marketplace in accordance with information derived from the encoded CRS travel data;
transmit instructions to generate a user interface regarding the travel item, the user interface comprising at least the set of human-readable information regarding the travel item and an input enabling a user to book the travel item on the electronic travel item marketplace; and
automatically booking the travel item in response to the user's election of the input.

12. The system of claim 11, wherein the request is submitted by the user.

13. The system of claim 12, wherein the hardware processor is further configured to execute computer-executable instructions to at least obtain at least one criterion corresponding to the user based, at least in part, on the analysis of the obtained encoded CRS travel data.

14. The system of claim 13, wherein the travel item is identified based, at least in part, on the at least one criterion.

15. The system of claim 13, wherein the set of human-readable information is determined in accordance with the at least one criterion.

16. A non-transitory computer readable storage medium storing computer executable instructions that when executed by a processor perform operations comprising:
obtaining, from a computing device of a travel agent, encoded CRS travel data corresponding to a request for travel item information;
determining a set of human-readable information regarding a travel item identified from an electronic travel item marketplace in accordance with information derived from the encoded CRS travel data;
transmitting instructions to generate a user interface regarding the travel item, the user interface comprising at least the set of human-readable information regarding the travel item and an input enabling a user to book the travel item on the electronic travel item marketplace; and
automatically booking the travel item in response to the user's election of the input.

17. The non-transitory computer readable storage medium of claim 16, wherein the operations further comprise:
obtaining the request for travel item information; and
transmitting the request to the computing device of the travel agent.

18. The non-transitory computer readable storage medium of claim 17, wherein the set of human-readable information includes at least one of supplemental or correctional information provided by the travel agent.

19. The non-transitory computer readable storage medium of claim 17, wherein the operations further comprise causing presentation of a preview of the user interface regarding the travel item to the travel agent.

20. The non-transitory computer readable storage medium of claim 19, wherein the operations further comprise obtaining an approval of the preview from the travel agent prior to transmitting the instructions to generate the user interface regarding the travel item.
